(19) United States
(12) Patent Application Publication
(10) Pub. No.: US 2003/0117280 A1
(43) Pub. Date: Jun. 26, 2003

(54) Security communication and remote monitoring/response system

(75) Inventor: Steven F. Prehn, Dexter, MI (US)

Correspondence Address: Theresa A. Orr, Dobrusin & Thennisch PC, Suite 311, 401 South Old Woodward Avenue, Birmingham, MI, 48009, US

(73) Assignee: Visionary Enterprises, Inc.

(21) Appl. No.: 10/325,215

(22) Filed: Dec. 20, 2002

Related U.S. Application Data
(60) Provisional application No. 60/342,705, filed on Dec. 20, 2001.

(51) Int. Cl. G08B 21/00

(52) U.S. Cl. 340/540; 340/573.1; 340/531; 340/541; 705/1

(57) ABSTRACT

The present invention relates to a method for receiving, selecting, and transmitting responsive commands for the monitoring and remote response to alarm or security conditions that may be detected in a property security system. The security system located at the designated property is in communications contact with the property owner or other designated individual/user/monitoring center via instant messaging technology or similar electronic communication methods with a device that the user can carry remotely. The steps of the security monitoring process include providing a computer for transmitting signals to and receiving signals from designated security equipment and devices disposed along selected portions of the designated property stored on a computer readable medium, transmitting a signal representative of a display of the security equipment in the on (alarmed) condition, off condition, security breach condition, and/or reset mode, and transmitting security event data to an operation center for dissemination to the property owner via instant messaging.

### CLAIM OF BENEFIT OF FILING DATE

The present application claims the benefit of the filing date of U.S. Provisional Application Serial No. 60/342,705 filed Dec. 20, 2001.

### TECHNICAL FIELD

The present invention relates to security communication systems and methods of monitoring, transmitting, and responding to triggering events or breaches in a security communication system. More particularly, the present invention relates to a security monitoring central station which monitors homes or other properties which provides a method for communicating directly with the property owner or other designated monitoring center or station via an electronic medium or digital means, such as instant messaging, text messaging, converted text messaging using a personal communications device, audio transmission, or transmission of video images of the property location, in the event that a security breach or other alarm condition is detected at the property. The system further comprises a plurality of response choices to the recipient of the electronic communication or instant message from the security system. For instance, the instant message transmission may be utilized by the property owner to alert law enforcement, request additional status, audio and video information, initiate steps to preserve and record audio, video, and other form of evidence, reset the system, engage a variety of alarms and lock-out procedures at the property location, disengage the system in the event of a false alarm or other non-threatening condition, or provide any number of command responses to the system via electronic, digital, conventional, or other wide area network method by which a remote user may initiate contact with the security system.

### BACKGROUND OF THE INVENTION

The ownership of property, and the desire to possess and maintain tangible assets and objects within such property, can be described as one of the most basic tenets of the human experience. Throughout human history, the ownership of property and objects has been equated with wealth, status, and power for both the individuals and/or families that control the property. Due to the value of property, a variety of steps and precautions are typically taken by the property owner to ensure that the property is not subject to theft, burglary, break-in, or other form of unauthorized and/or unlawful conversion by others.

Traditional prior art devices and systems have generally utilized so-called “hard wired” monitoring services or systems wherein the property owner contractually engages a security service which equips and installs the designated property or home with a security and alarm system, including associated infrastructure and peripherals, at various points of potential ingress and egress of the designated property. Typically, the installation of such security and alarm systems and equipment requires modifications and alterations to both interior and exterior portions of the property to be secured, including additions and modifications to the existing electrical systems of the property. The security systems known in the prior art provide detection of a variety of alarm conditions or events. Such systems are commercially available through a variety of providers including ADT Security Systems, Brink's Home Security, PELCO, and Protection One among others. For instance, prior art alarm systems can range from detection of the unauthorized opening of exterior doors and windows, to motion-sensing technology within predetermined portions of the property, video surveillance, as well as equipment to detect raises in ambient temperature in the event of fire. In addition to the expense incurred by the purchase and installation of the physical security equipment, the typical prior art security system also requires the purchaser or property owner to enter into a service or monitoring contract wherein the property owner is charged a monthly monitoring fee to service and monitor the property for an alarm event or other form of detectable security breach. Generally speaking, the monitoring service or contract service provider has a communications or data link to applicable local law enforcement or emergency service personnel in the geographic or jurisdictional area corresponding to the location of the property. Typically, the service operates a telephone call center, which attempts to verify the validity of an alarm by contacting the property owner via telephone at the property to inquire as to the source of the alarm condition. If no response is received to the telephone query, the call center contacts local emergency services personnel to respond to the alarm. If the call center reaches the property owner via telephonic contact, a pre-arranged protocol is initiated wherein the service center requests a verbal password to ensure that the call center has, in fact, reached the true and authorized property owner. At that stage, the protocol either verifies the authorized property owner by password and deactivates the system as a “false alarm”, inadvertent set-off, or then contacts local emergency services personnel for further investigation of the property.

Although these prior art systems do provide a level of security protection to property owners and work well in a variety of applications, they require the expenditure of a relatively large amount of financial resources on the part of the property owner to install and maintain. For example, the property owner must often purchase a recommended equipment package for the designated property and then enter into a long-term contractual commitment for on-going monitoring and service of the system. Further, the property owner is typically charged for excessive false alarms or inadvertent set-off's of the system which can often be attributable to pets, family members, or other unavoidable causes. Still further, the required monitoring service and/or call center does not possess adequate means to validate of the alarm condition and therefore, limits the true effectiveness of the alarm system. In addition, many commercial and residential landlords preclude their commercial and residential tenants from utilizing the prior art systems since the terms of the lease prohibit making the necessary modifications and installations of the leasehold premises to install the security equipment, or having made these changes would otherwise result in additional charges to the lessee. Moreover, many security conscious consumers are also sensitive to privacy concerns and would like to utilize a system where they could self-direct or self-monitor the security of a designated property. In this regard, many property owners are desirous, to select and equip their designated property location with alarm and security equipment of their own choosing without the necessity of hiring outside personnel to enter their premises and install a system. An individualized and self-monitored system would also limit the number of individuals having knowledge of the extent and operation of a given system as well as prevent the possibility of unauthorized monitoring or eavesdropping by service personnel as well as intrusions in the personal privacy of a secured location, particularly in cases where a security system comprises audio and/or video monitoring and recording capabilities.

Accordingly, there is a need for a low-cost alarm and security system which can be monitored by the property owner or cost-effective monitoring service which provides a means for disseminating and communicating with a mobile, remote, or transient property owner in the event that a security breach or alarm condition is detected at the property. The present invention obviates and overcomes the drawbacks found in the prior art by providing a low-cost kit, system, and method for remote monitoring of a security system through instant messaging techniques to the property owner that may also convey audio, video, and/or audiovisual conditions at the subject property to assist the property owner in determining a necessary response. Once the property owner is alerted of an alarm condition via instant messaging, a property owner employing the present invention may respond to the security system via the same electronic or digital mediums to either gain additional information or data concerning the alarm event by monitoring audio and/or video devices at the property, initiate data and image preservation techniques, initiate audible alarm measures at the property, initiate a lock-out or lock-down protocol at the property to safeguard the premises from further infiltration, reset and/or deactivate the system in the event of a false alarm, or contact local emergency services and/or law enforcement personnel in the event of a bona fide security breach.

### SUMMARY OF THE INVENTION

The present invention relates to a method and apparatus for receiving, selecting, and transmitting responsive commands for the monitoring and remote response to alarm or security conditions that may be detected in a property security system. In a preferred embodiment, the security system located at the designated property is in communications contact with the property owner or other designated individual/user/monitoring center via instant messaging technology with a device that the user can carry remotely. However, one of ordinary skill in the art will appreciate that the security system described in the present invention need not be limited to a placement at a fixed location, such as a domicile or other physical property, but could be utilized on vehicles, freight, and other mobile forms of property. In addition, the means of contact between the security system and the designated property owner or monitoring center may not be limited to electronic message technology, but may further comprise audio, text, video, and/or audiovisual messaging content or other forms of transmissions giving detailed information and images of the property in real time along with a command menu of potential response command choices and protocols. In this regard, it is also contemplated that the present invention may comprise additional software, hardware, and peripherals to provide text messages or convertible text message data streams from the security system to a personal communications device, such as a telephone, PDA, smart appliance, or the like, which may be remotely transported and used by the property owner.

The steps of the security monitoring process include providing a computer for transmitting signals to and receiving signals from designated security equipment and devices disposed along selected portions of the designated property stored on a computer readable medium, transmitting a signal representative of a display of the security equipment in the on (alarmed) condition, off condition, security breach condition, and/or reset mode, and transmitting security event data to an operation center for safe off site storage and dissemination to the property owner or other designated contacts via instant messaging. It will be appreciated that a number of security devices are known in the art which can detect the unwanted opening and/or jarring of doors and windows, motion-sensing equipment, as well as audio, video, olfactory, tactile, and temperature sensing security equipment, any of which may be placed singly or in combination throughout the designated property to provide a desired level of security and expense range.

The computer controlling the security monitoring process is associated with a server for permitting data communication between the computer and one or more property owner operated devices. In a preferred embodiment, this data communication with the property owner is accomplished through, but is not limited to, instant messaging. The computer readable medium associated with the computer is programmed with software instructions for retrieving and sending an existing alarm condition to the property owner via instant messaging as well as receiving responsive commands from the property owner to respond to the alarm condition, all of which is stored on the computer readable medium.

The alarm condition notification generated by the computer includes alphanumeric as well as graphic representations of the alarm conditions and may include a grid or plot of the property and/or security system delineating precisely where the alarm condition was detected. The alarm condition display may also include a list of options available to the property owner to respond to the alarm condition notification. Namely, once the property owner has received an indication of an alarm condition from the security monitoring process, the computer generates and transmits via the server a signal confirming the property owner's command response information. Next, the property owner is prompted to choose among displayed response command options such as alerting local law enforcement via either electronic or conventional means, disarming the security system in the event of a false alarm, resetting the system, or initiating a predetermined data and/or evidentiary preservation protocol wherein the security equipment at the property location is instructed to begin recording audio, video, and/or other instructions such as a lockdown of highly secured portions of the property or tracking of specific objects located within the property (i.e. vehicle tracking systems that are well known in the art).

The property owner's response command is automatically associated with a specific operation center for processing. The computer activates a search algorithm that cross-references the response command received with a protocol sequence and responsive information stored on the computer readable medium for each operation center. The search algorithm executes a function that locates the operation center serving the owner's command response based on selected parameters such as contacting local law enforcement, shutting down the alarm system, resetting the system, or initiating evidentiary preservation protocols discussed above. In a preferred embodiment, each operation center is assigned a unique code, and each is assigned a unique identifier. The property owner's response command code is associated with an operation center code, wherein the selected operation center prepares, and in some instances places, the selected response command sequence in data communication with the security monitoring system or local law enforcement personnel.

In another embodiment, the invention relates to a system for transmitting alarm condition data to property owners via electronic means, such as instant messaging and response command responses received from the property owner in response to the alarm condition data to a preselected location. The system includes a security monitoring center for transmitting signals to and receiving signals from property owner operated devices, wherein the monitoring center receives alarm condition information in the form of detections and breaches of physical security equipment and infrastructure disposed at predetermined portions of the property; an operation center in data communication with the security monitoring center for transmitting and receiving data and commands to and from the property owner; and a communications network for providing a data communication between the security monitoring center and one or more property owner operated devices, such as instant messaging equipment.

The security monitoring center includes a computer having a computer readable medium programmed with computer program instructions for processing alarm condition or alarm event data. The computer readable medium includes program instructions for displaying alarm condition items and processing property owner information to the property owner via electronic and/or digital means, such as instant messaging, based upon the detected alarm condition or alarm event. The computer readable medium also includes program instructions for transmitting signals to and receiving signals from property owner operated devices from a remote location, comparing command response data received from the property owner with command response profile information and response protocols stored on the computer readable medium, retrieving an existing response protocol or profile from a database stored on the computer readable medium or creating a command response protocol if no existing file is available, transmitting a signal representative of the alarm condition or alarm event detected at the property, transmitting a visual display including a graphic representation of the alarm condition, transmitting a visual display including an alphanumeric representation of the alarm condition which may include a coded protocol, transmitting property owner response command data to an operation center for placement, selecting and assigning the response command data to an operation center, assigning the operation center a unique code, confirming the property owner command data, executing the command response, permitting property owner tracking of a command response, and automatically transmitting an electronic message, such as an instant message, advising the property owner of the continuing status of the alarm condition.

It is contemplated that communications between the property owner and the security monitoring center and the security monitoring center and the operation center can be over a wide area network, local area network, cable television cable network or an Internet connection, virtual private network or any other communication system permitting communication with remote devices, including PDA's and smart appliances.

These and other objects of the present invention will become apparent upon reading the following detailed description in combination with the accompanying drawings, which depict systems and components that can be used alone or in combination with each other in accordance with the present invention.

### BRIEF DESCRIPTION OF THE DRAWINGS

FIG. 1 is a schematic diagram illustrating a security communication and remote monitoring/response system formed in accordance with the teachings of this invention.

FIGS. 2A-2C is a flow chart diagram illustrating a security communication and remote monitoring/response system formed in accordance with the teachings of this invention.

### DESCRIPTION OF THE PREFERRED EMBODIMENT

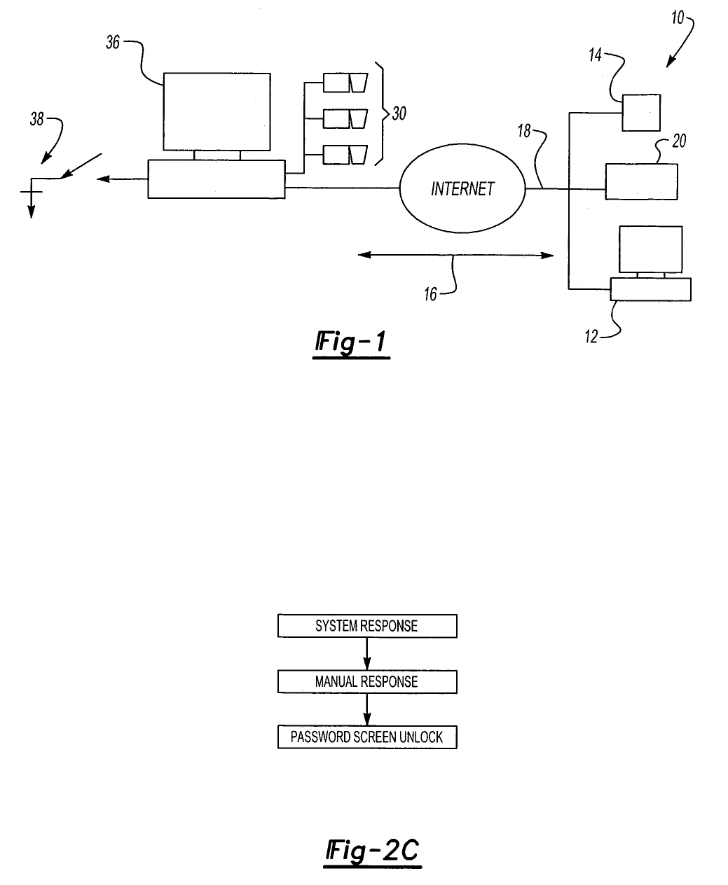

FIG. 1 is a schematic diagram illustrating a security communication and remote monitoring/response system formed in accordance with the teachings of this invention. The purpose of such a system is to provide an advanced method of security event escalation by utilizing the features and capabilities associated with Instant Messaging to manage, record and archive detected events and images of a registered user's, i.e. a property owner, security system and coordinate notification among a plurality of users, devices and emergency response organizations. The user of this service can provide verification of the event having accessed information from the registered security system and instruct the central security monitoring service and original system how to respond.

The security system 10 of the present invention includes a computer system 12, a camera 14, at least one Instant Message device 16 and an Internet communication means 16. In a preferred embodiment, the computer system 12 is a personal computer supporting a software application that can detect an intruder through analyzing images provided by a USB camera 14 connected to the personal computer 14. The camera 14 captures and records images of an intruder and contacts a property owner via the Internet by either sending images of the intruder via commonly available communication method or using Instant Messaging protocol, images, and/or combinations thereof. Instant Messaging is used to communicate security notifications and control the monitoring system/personal computer 12 remotely from virtually anywhere in the world.

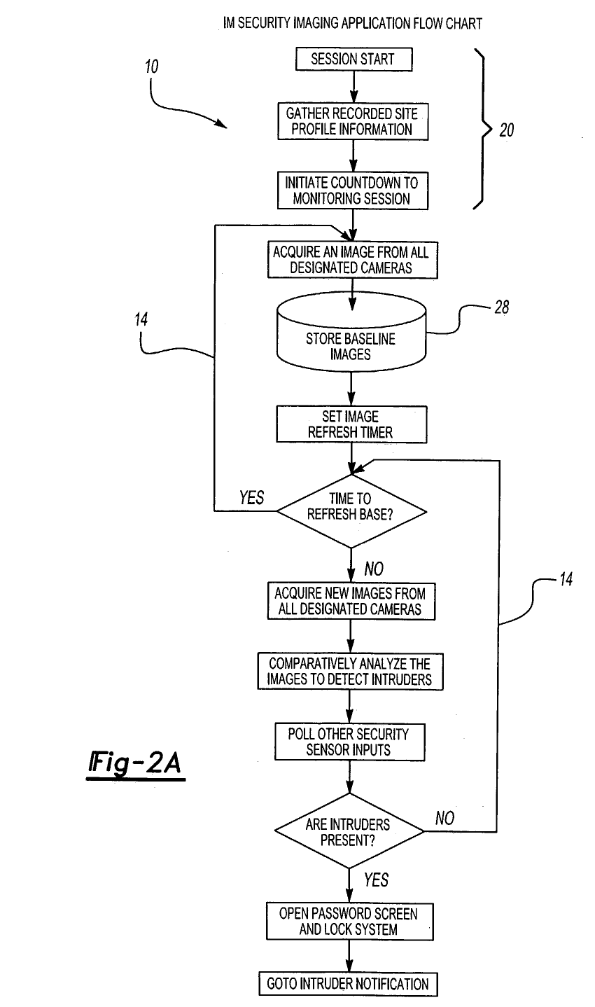

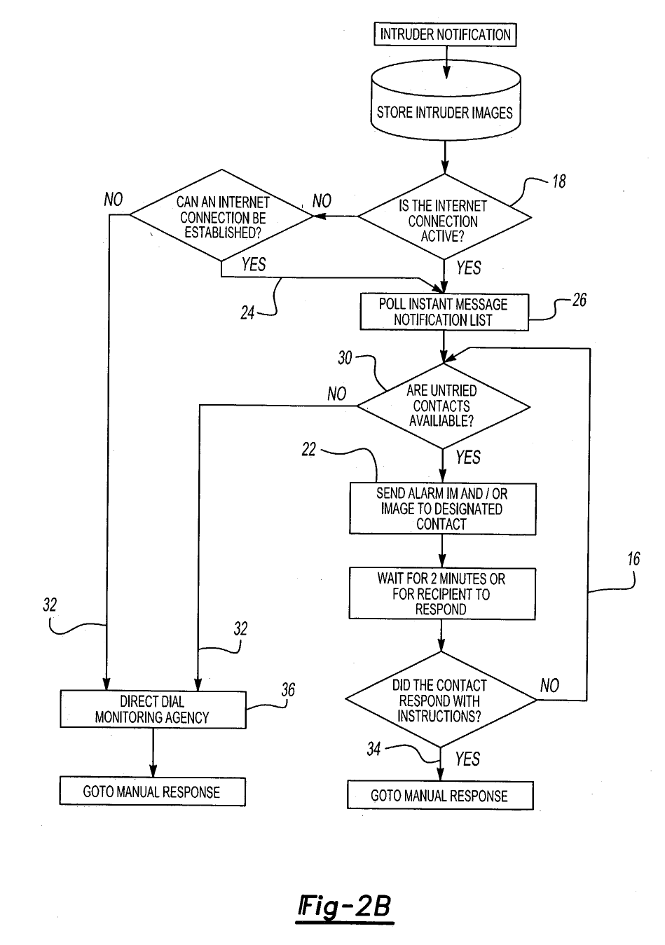

With reference to FIG. 2, a preferred method of the present invention is there shown and includes a security system 10, containing a central processing unit such as a personal computer 12, a camera 14 and a software application 20. The security system 10 uses image processing techniques to detect intruders by recognizing changes with subsequent camera images. If the security system 10 detects potential intruders, if generates an alarm condition and transmits a coded signal 22 to an Internet based utility application 24 via Internet communication 18 of the personal computer 12.

The Internet utility application 24 verifies the originating system's 10 identification from records stored within an Internet database 26. Upon verification, the Internet based utility application 24 instructs the security system 10 to transmit images of the potential intruders and of the unverified crime scene of a designated property 28. Having received images from the security system 10, the Internet utility application 24 records the images.

The Internet utility application 24 then automatically instructs the security system 10 to seek verification of the alarm condition by contacting a designated property owner and other members 30 contained on a security contacts list. Using Instant Messaging 16, the security system 10 polls the status of all the members 30 of the contact list and attempts to contact each member it has determined is currently available on-line, i.e. in communication with the Internet, where each member 30 is secured with a device capable of receiving and transmitting by Instant messaging protocol. The Instant Message 16 sent by the security system 10 and received by the contact member 30 contains information that identifies the security system 10.

Two-way communication between the security system 10 and the contact member 30 exists through available communication methods such as sending images and/or Instant Messaging techniques or other electronic means. During alarm condition periods, the security system 10 is monitored by the Internet Utility application 24 and all Instant Message correspondences with the contact member 30 are recorded by the Utility application 24. The contact member 30 can instruct the security system 10 to transmit additional information, including, but not limited to, images, video and audio that will aid the member 30 in determining the validity of the break-in event. Additionally, the contact member 30 has the ability to instruct the security system 10 on how to respond to the alarm event, preferably by sending coded messages via Instant Messaging 16. These coded messages sent by the contact member 30 to the security system 10 include but are not limited to, turning the system off, notifying the authorities or canceling the alarm condition. These communications and instructions from the member 30 are monitored by the Internet Utility application 24 and stored within the Internet database 26.

If the alarm condition is confirmed by the contact member 30, or the security system 10 does not receive confirmation from one of the contact members 30 within a set period of time, a code 32 representing a higher urgency is sent to the Utility program 24. The Utility program 24 responds to this code 32 by creating a event summary packet of information 34 and transmits this packet 34 to a monitoring agent 36, alerting them of the need to respond to an alarm event at the location of the security system 10. The monitoring agent 36 can contact the authorities directly if the code sent to them indicates the alarm condition has been verified by the contact member 30.

Alternatively, the monitoring agent 36 will respond to the alarm by calling the location of the security system 10 or designated property 28 if the alarm event has not been verified by a contact member 30, to attempt to verify the validity of the alarm event. Persons answering the telephone at the location of the security system 10 will be asked to provide the monitoring agent 36 a password that is stored in the database 26. It the password is correct, the monitoring agent 36 will remotely return the security system 10 to a normal state and assume the security system 10 was inadvertently triggered. Alternatively, the person answering the call at the location of the security system 10 may provide the monitoring agent 36 with a holdup password, indicating they are in jeopardy of a physical assault. The agent 36 will react to ensure the authorities 38 are alerted if this is a potential robbery attempt, or the holdup password is given.

The security system of the present invention is viable for not only homeowners, but also renters, such as college students, where hard wiring of security equipment is not available. The security system 10 provides a portable solution. Additionally, the security system of the present invention enables people to monitor their own homes and loved ones instead of relying fully on others to do it for them. Whether at work or out for the evening, the security system 10 can notify a member in the event of a break-in using Instant Messaging sent to a personal computer, Palm Pilot, or cellular phone, for instance. Because Instant Messaging techniques recognize either the availability or unavailability of a contact member, critical time is not lost tracking down the property owner or member designated as the monitoring resource. In the event that no members are available, a monitoring agent 36 will respond to the alarm notification.

Instant Messaging is real-time communication, allowing immediate response to critical break-in events or verifies a false alarm by notifying a member and sending an image of the potential intruder. If the property owner is unavailable, other members, designated by the property owner, may be notified to respond to the alarm. Additionally, image processing technology is used to detect and record potential intruders. The recorded images may be sent to a member and to a third party such as the police. This dynamic image processing technique eliminates individually wired sensors while providing a wide viewing area.

Other messaging protocol is envisioned including but not limited to Microsoft Network Messenger (MSN), America Online Messenger (AIM), Yahoo, ICQ and others. Additionally, wireless devices such as cell phones and personal data systems may be used. Cell phones such as Sprint PCS Sprint Vision phones may be used and PDA's such as Palm, HandSpring, Toshiba, Compaq/HP and other PDA manufacturers have implemented Instant Messaging utilities that are capable of communicating with and receiving images from the security system of the present invention.

It is envisioned that the imaging software provided with the security system of the present invention is capable of differentiating pets from potential intruders. Preferably, a “smart” algorithm will apply known characteristics of a pet to eliminate potential triggering of an alarm by the family pet. Additionally, the software is preferably able to disregard the effects of lightning flashes or gradual changes in the ambient light levels.

The imaging device or camera of the present invention may be attached to the personal computer (PC) in a number of ways, including but not limited to USB, Firewire (IEEE 1394), Serial, through a PC card or parallel connection, wireless or wired. Additionally, the camera used may include special properties such as low light level, infrared, motion activated, Ultra Sonic, active or passive sensors.

Other input devices may replace or enhance the functionality of the security system of the present invention. Such devices may include, but are not limited to window interlocks, motion detectors, glass break detectors, audio triggers, microwave or ultrasonic detectors, photo electric eyes, and infrared detectors. Additionally, the security system of the present invention can be implemented to notify a member in the case of a fire or environmental change. Detector devices may include smoke detectors, thermal rate change detectors, bimetal detectors and water, moisture and pressure sensors.

Integrated within the camera may be hardware or software that performs the detection of a possible intruder. Such camera systems are commonly referred to as a “smart camera.” Use of such a camera with the security system of the present invention provides a member with security applicable to a non-PC system. This “smart” security system may communicate wirelessly, or be directly connected to the Internet. “Smart Camera” security systems may have their Internet Protocol (TCP/IP) communication capability built in and may include the ability to communicate using Instant Messaging protocols.

Two general modes of monitoring are addressed by the software—immediate and buddy monitoring. Immediate monitoring refers to instances where the monitoring agent is selected to be the default monitoring selection. In general, this type of monitoring is recommended where property owner/members are known to be present within the designated property. For example, a member activates the security system alarm within their home before going to bed. The first priority of the system is to immediately alert the member of a potential threat. Preferably, the system will sound an audible beeper and will then proceed to alert the monitoring agent of a suspicious activity. The system will show a warning message, preferably via Instant Messaging, and allow the member a time period to disable the system by entering a proper password. In this monitoring mode, the monitoring agent is notified prior to other designated members.

In a buddy monitoring mode, the property owner/member is not within the vicinity of the designated property, i.e. is generally not at home, and the security system described above provides self-monitoring by a member, thereby reducing false alarms to the local police department.

With the security system of the present invention, it is envisioned that every person permitted to enter the designated property will know the password or code to disable the security system. A second code, or “hold up” code may be entered in place of a password which appears to all parties to have disabled the security system, but in fact alerts the monitoring agent that the property owner/member is experiencing an emergency situation.

Preferably, the monitoring agent will be exposed to several levels of security when alerted to the monitoring of a designated property. These levels include but are not limited to Level 0—all clear, system currently monitoring; Level 1—initial potential intruder detected; Level 2—no password has been entered within the time period allotted, security system is now sending Instant Message to all members; Level 3—monitoring agent is requested to respond to the potential intrusion by calling the designated property owner/designated property and asking for a password or code; Level 4—monitoring agent should contact local police immediately where a member or other person has indicated the presence of a real intruder. Where the system is shut down without a password entered, the monitoring agent assumes a Level 3 status. This may occur where power is lost or when the computer system is rebooted.

Although the invention has been described with particular reference to certain preferred embodiments thereof, variations and modifications can be effected within the spirit and scope of the following claims.

1. A method for monitoring a security communications system for at least one designated property comprising the steps of:
providing a computer for transmitting signals to and receiving signals from designated security equipment and devices disposed along selected portions of a designated property stored on a computer readable medium;
transmitting a signal representative of a display of said security equipment by said computer for detection of security event data;
retrieving said display data by said computer;
sending security event data to an operation center for off site storage and dissemination of said display of said designated property to a property owner; wherein a property owner includes at least one member provided to said security system and designated as a security contact;
responding to said security event data by a property owner; and
directing said computer to respond to said security event data by a property owner.

2. The method for monitoring a security communications system of claim 1, wherein said computer is a personal computer including a video camera having a connection to the Internet.

3. The method for monitoring a security communications system of claim 2, wherein said personal computer and said video camera further comprise an image software application, and including the steps of:
after retrieving said display data, said image software monitoring and analyzing images provided by said camera, including detecting changes in the area surrounding said designated property, capturing images of said changes, storing said images on said computer readable medium, and generating an alarm condition.

4. The method for monitoring a security communications system of claim 3, wherein said system further comprises an Internet based utility application for receiving a coded signal transmitted from said security system when said alarm condition is generated.

5. The method for monitoring a security communications system of claim 4, and further comprising the steps of once said utility application receives said coded signal, said application includes:
verifying the origin of said coded signal;
identifying and comparing said coded signal and said security system with records stored within said utility application;
instructing said security system to transmit said stored images;
receiving and recording said images;
instructing said security system to seek verification of said alarm condition by a property owner;
monitoring communications between said security system and a property owner; and
recording all communications between said security system and a property owner.

6. The method for monitoring a security communications system of claim 5, wherein the step of seeking verification of said alarm condition by said security system includes the steps of:
using Instant Messaging by said security system to seek said verification including the steps of;
polling the status of a property owner and all other members of said security contact list via Instant Messaging;
contacting each of said members via Instant Messaging currently in communication with and available on-line with the Internet;
maintaining and receiving two-way communication with said available members via Instant Messaging including said security system providing information identifying said security system and said alarm condition;
receiving instructions for responding to said alarm condition from said member to said security system via Instant Messaging; and
carrying out said instructions.

7. The method for monitoring a security communications system of claim 6, wherein if said alarm condition is verified by said member, said security system method further comprises the steps of:
sending a code representing a higher urgency to said utility application;
creating an event summary packet of information in response to said code by said utility application;
transmitting said summary packet to a monitoring agent by said utility application;
receiving of said summary packet by said monitoring agent; and
responding to said code received by said monitoring agent.

8. The method for monitoring a security communications system of claim 7, wherein if said alarm condition is not verified by a property owner or at least one of said members, a different code representing a failure to contact and verify said alarm condition is sent to said utility application.

9. The method for monitoring a security communications system of claim 8, wherein said responding step includes at least one of the following:
if said code indicates to said monitoring agent that said alarm condition has been verified by a property owner or at least one of said members, contacting emergency authorities directly by said monitoring agent; and
if said code indicates to said monitoring agent the failure to contact and verify said alarm condition, re-contacting a property owner or at least one of said members seeking verification of said alarm condition.

10. The method for monitoring a security communications system of claim 9, and further comprising the steps of:
wherein if said step of re-contacting a property owner or at least one of said members results in a failure to re-contact, then contacting emergency authorities directly by said monitoring agent;
wherein if said step of re-contacting a property owner or at least one of said members is successful, then contacting emergency authorities if said alarm condition is verified; and
wherein if said step of re-contacting a property owner or at least one of said members is successful, then remotely returning said security system to a normal state if a property owner or at least one of said members if alarm condition is confirmed as a false alarm.

11. A method for monitoring a security communications system for at least one designated property, said security system including personal computer communicating with a video camera via an image software application and connected to the Internet for implementing an Internet based utility application for communication with at least one member and at least one device provided to said security system and designated as a security contact, comprising the steps of:
using Instant Messaging to communicate security system results to a second device;
using Instant Messaging to respond to said second device in the manner designated by said second device; and
communicating said alarm condition received by said second device to a third party.

12. The method for monitoring a security communications system for at least one designated property of claim 11, said step of using Instant Messaging to communicate security system results to a second device further including the step of:
reporting security alarm conditions via Instant Messaging, including images of said at least one designated property.

13. The method for monitoring a security communications system for at least one designated property of claim 12, said step of using Instant Messaging to communicate security system results to a second device further including the step of:
establishing auto detection of entries on the notification list thereby designating the availability of said devices to notify.

14. The method for monitoring a security communications system for at least one designated property of claim 13, said step of using Instant Messaging to communicate security system results to a second device further including the step of:
automatically propagating notification to other of said members via said designated devices if no response is specified within a designated period of time.

15. The method for monitoring a security communications system for at least one designated property of claim 11, said step of using Instant Messaging to communicate security system results to a second device further including the step of:
manually sending a notification to a designated member in the case where an alarm condition exists at said designated property.

16. The method for monitoring a security communications system for at least one designated property of claim 15, said step of using Instant Messaging to respond to said second device in the manner designated by said second device further including the step of:
directing said security system to record events for said at least one designated property, wherein said events include one of the following designated events: images received from said camera, sound received from said camera, movement received from said camera and indications from sensors or switches further included with said security system and received by said computer and said camera.

17. The method for monitoring a security communications system for at least one designated property of claim 16, said step of using Instant Messaging to respond to said second device in the manner designated by said second device further including the steps of:
overriding said alarm condition in the case of false alarms, or acceptable unforeseen entries;
turning said security system on or off;
requesting a status report from said security system;
placing said security system into a locked mode, thereby restricting access to the contents of the recording system;
activating an audible siren, speaker system or flashing lights;
re-training the camera system template image for visual detection;
changing the sensitivity of detection for said devices; and
controlling any action within said at least one designated property in response to said notification of said security system results.

18. The method for monitoring a security communications system for at least one designated property of claim 17, said step of communicating said alarm condition received by said second device to a third party further including the steps of:
redirecting notification to said designated recipient;
forwarding said notification to said third party, said third party including but not limited to local law enforcement, a professional monitoring organization, and another recipient;
copying another party upon said notification; and
responding to said notification through a second communication path.

19. A method for monitoring a security communications system for at least one designated property, said security system including personal computer communicating with a video camera via an image software application and connected to the Internet for implementing an Internet based utility application for communication with at least one member and at least one device provided to said security system and designated as a security contact, comprising the steps of:
using Instant Messaging to communicate security system results to a second device;
using Instant Messaging to respond to said second device in the manner designated by said second device, including the step of directing said security system to record events for said at least one designated property, wherein said events include one of the following designated events: images received from said camera, sound received from said camera, movement received from said camera and indications from sensors or switches further included with said security system and received by said computer and said camera; and
communicating said alarm condition received by said second device to a third party.

20. The method for monitoring a security communications system for at least one designated property of claim 19, said step of using Instant Messaging to communicate security system results to a second device further including the steps of:
reporting security alarm conditions via Instant Messaging, including images of said at least one designated property;
establishing auto detection of entries on the notification list thereby designating the availability of said devices to notify;
automatically propagating notification to other of said members via said designated devices if no response is specified within a designated period of time; and
manually sending a notification to a designated member in the case where an alarm condition exists at said designated property.

21. The method for monitoring a security communications system for at least one designated property of claim 20, said step of using Instant Messaging to respond to said second device in the manner designated by said second device further including the steps of:
overriding said alarm condition in the case of false alarms, or acceptable unforeseen entries;
turning said security system on or off;
requesting a status report from said security system;
placing said security system into a locked mode, thereby restricting access to the contents of the recording system;
activating an audible siren, speaker system or flashing lights;
re-training the camera system template image for visual detection;
changing the sensitivity of detection for said devices; and
controlling any action within said at least one designated property in response to said notification of said security system results.

22. The method for monitoring a security communications system for at least one designated property of claim 21, said step of communicating said alarm condition received by said second device to a third party further including the steps of:
redirecting notification to said designated recipient;
forwarding said notification to said third party, said third party including but not limited to local law enforcement, a professional monitoring organization, and another recipient;
copying another party upon said notification; and
responding to said notification through a second communication path.
